(19) United States
(12) Patent Application Publication
(10) Pub. No.: US 2017/0095987 A1
(43) Pub. Date: Apr. 6, 2017

(54) SHOE INSOLE AND MANUFACTURING METHOD THEREOF

(71) Applicants: JUNG-CHUNG FENG, Taichung City (TW); KANG-YEN FENG, Taichung City (TW); CHING-WEN FENG, Taichung City (TW); CHING-CHIAO FENG, Taichung City (TW)

(72) Inventors: JUNG-CHUNG FENG, Taichung City (TW); KANG-YEN FENG, Taichung City (TW); CHING-WEN FENG, Taichung City (TW); CHING-CHIAO FENG, Taichung City (TW)

(21) Appl. No.: 15/273,638

(22) Filed: Sep. 22, 2016

(30) Foreign Application Priority Data
Oct. 2, 2015 (TW) 104132492

(51) Int. Cl. B29D 35/12; B29D 35/14; A43B 17/08; A43B 17/14; A43B 17/02; B29B 9/02; A43B 17/00

(52) U.S. Cl. CPC B29D 35/12; B29B 9/02; B29D 35/14; A43B 17/006; A43B 17/14; A43B 17/02; A43B 17/08; B29K 2105/04

(57) ABSTRACT

Disclosed are a shoe insole and its manufacturing method. The method includes the steps of crushing a rubber foam material into irregular primary crushed particles, covering a mixed elastomeric material onto a surface of the primary crushed particle uniformly, using a pressurizing, heating and curing method to form a primary modified foam material, crushing the primary modified foam material again to form irregular secondary crushed particles, covering the secondary crushed particles uniformly mixed with the elastomeric material onto a surface of the secondary crushed particle, and using the pressurizing, heating and curing method to form a secondary modified foam material similarly. The shoe sole made of the secondary modified foam material has good breathability, elasticity, comfortability and compressive strength.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

Field of Invention

The present invention relates to a shoe insole manufactured by a method that crushes and combines a rubber foam material repeatedly to change the physical properties of the rubber foam material and improve the breathability, elasticity, and compressive strength of the shoe insole.

Description of Related Arts

At present, rubber foam materials including Styrene-Butadiene Rubber (SBR), Chloroprene Rubber (CR), Nitrile Butadiene Rubber (NBR), and any mixture of the above are not used for manufacturing shoe insoles, since these foam materials are not suitable for manufacturing the shoe insoles. Common foam materials used for making shoe insoles include an Ethylene Vinyl Acetate (EVA) foam material, a thermoplastic polyurethane foam material or a natural latex foam material, etc. The EVA foam material mainly composed of a raw material of Ethylene Vinyl Acetate (EVA) or its mixture is a foam having many independent air bubbles, and the EVA shoe insole has the advantages of low material cost, easy formation, light foam density, non-absorbent and the disadvantages of low breathability, poor elasticity, small compression tolerance, low flexibility, and low durability, and such shoe insole may cause stuffy heat to the user's feet. Many industrial or patent documents have disclosed various different methods for overcoming the drawbacks of the EVA shoe insole, and most technical contents of these improvement methods are nothing more than forming concave and convex dots or grooves on the conventional EVA shoe insole by compression molding or adding a layer of breathable cotton fabric or other breathable material on the whole surface, a part of the surface, or the uppermost layer of the surface to achieve the breathable effect, but these methods are unable to improve other drawbacks. To overcome the elasticity issue of the EVA shoe insole, rubber materials including POE, EPDM, TPR, IR, NR, SBR, and CR are mixed into the EVA raw material, or the rubber materials are foamed after kneading, and the characteristics of the rubber are used to improve the overall elasticity of the EVA foam material. Although these methods can improve the elasticity, they still cannot overcome the drawbacks of poor breathability, compressive strength, and stuffy heat of feet.

Another shoe insole is made of a two-liquid PU foam material and formed by direct injection, foaming and formation. Such shoe insole has the advantages of providing better bounce and breathability and smaller foaming density for formation than EVA and the disadvantages of absorbing water and sweat easily, accumulating strange and bad smells after a long time of use, and failing to withstanding pressure for a long time of use.

In addition, there is also a shoe insole made of a two-liquid PU foam, wherein recycled PU foam materials are crushed into very small strips to be used as a filler, and then a raw material of the PU foaming material is foamed to form a breathable PU foam material, and such shoe insole has the advantages of providing good comprehensive breathability, elasticity, and density and the disadvantages of absorbing water and sweat easily, accumulating strange and bad smells after a long time of use, and lacking the soft comfortable feeling.

In addition, there is also a shoe insole made of natural rubber latex by foaming, and such shoe insole has the advantages of good elasticity and softness, and the disadvantages of having a bad breathability, absorbing water and sweat easily, accumulating strange and bad smells after a long time of use, and failing to withstanding compression.

### SUMMARY OF THE PRESENT INVENTION

In view of the drawbacks of the conventional shoe insole made of a foam material, it is a primary objective of the present invention to provide a novel shoe insole for the main purpose of giving good comprehensive breathability and high elasticity and compressive strength to the shoe insole, so as to achieve the effects of providing low compressibility and soft comfort and featuring low water and sweat absorption and the physical properties for discharging water and sweat quickly.

To achieve the aforementioned and other objectives, the present invention provides a shoe insole manufacturing method, comprising the steps of: (a) using a rubber foam to material or mixing more than one rubber foam materials as a main raw material, and crushing the rubber foam material into irregular primary crushed particles; (b) using an elastomeric material or mixing more than one elastomeric materials as a main raw material, preparing a fluid of a first elastomeric layer, and adding a matched curing agent; (c) covering the fluid of the first elastomeric layer comprehensively and uniformly onto a surface of the primary crushed particles by a blending and mixing method; (d) using a pressurizing, heating, and curing method to combine the primary crushed particles and the first elastomeric layer to form a whole chunk of a primary modified foam material; (e) crushing the primary modified foam material into irregular secondary crushed particles; (f) using an elastomeric material or mixing more than one elastomeric materials as a main raw material, preparing a fluid of a second elastomeric layer, and adding a matched curing agent; (g) covering the fluid of the second elastomeric layer comprehensively and uniformly onto a surface of the secondary crushed particles by a blending and mixing method; (h) using a pressurizing, heating, and curing method to combine the secondary crushed particles and the second elastomeric layer to form a whole chunk of a secondary modified foam material; and (i) forming a shoe sole product by using the secondary modified foam material. Wherein, the secondary modified foam material is composed of a foam material of 85 to 35% by weight, an elastomeric material of 15 to 60% by weight and a curing agent of 0 to 5% by weight.

The shoe insole made of a rubber foam material with good resilience, softness, and durability and manufactured according to the aforementioned method. It is necessary to crush the foam material into small foam particles before use, and the crushing step is intended to obtain the comprehensiveness and excellent breathability. One or more elastomeric materials and foam materials with specific physical properties are mixed, cured, and combined to form a comprehensive and uniform foam material, and the combining step is intended to provide the features of the good strength, elasticity and tenacity of the elastomeric material, so as to effectively and specifically provide excellent reinforcement and enhancement of compressive strength and elasticity to the surfaces of the small foam particles with reduced physical properties after crushing. The elastomer must be prepared in form of fluid for its use in order to allow the elastomer to be uniformly attached to the surfaces of the small foam particles, so that a film layer formed by the pressurizing and heating method can be attached onto the surfaces of each small foam particle. In the meantime, the fluid has the adhesive function, so that a new-structured foam material can be formed. The aforementioned rubber foam material and elastomeric material are made of a hydrophobic material, so that water and sweat will not be attached easily and can be evaporated quickly. Further, the pressurizing and curing steps are carried out to combine and form a whole chunk of a modified rubber foam material with specific physical properties. For the shoe insole still failing to meet the manufacturing requirements for the first time of changing the physical properties, a second time or more times of changing the physical properties may be required to meet the required physical properties. The elastomeric material used for the second time or more times may be the same as the elastomeric material used for the first time, or another totally different elastomeric material, and the multiple of combinations may give several types of novel modified foam materials with different physical properties to meet the requirements of different applications of the shoe insole. Therefore, the novel modified foam material has the aforementioned physical properties and advantages including the good comprehensive breathability, high elasticity, high compressive strength, low compressibility, very soft comfort, high resistance to reduced thickness after a long time of use, low water and sweat absorption, and a quick water and sweat discharging effect.

### BRIEF DESCRIPTION OF THE DRAWINGS

FIG. 1 is a flow chart of a manufacturing method of the present invention;

FIG. 2 is a perspective view of a rubber foam material of the present invention;

FIG. 3 is a sectional view of a primary crushed particle of the present invention;

FIG. 4 is a sectional view of a surface of a primary crushed particle covered by a first elastomeric layer in accordance with the present invention;

FIG. 5 is a sectional view of a primary foam material formed into a whole chunk after being pressurized and heated;

FIG. 6 is a sectional view of a secondary crushed particle of the present invention;

FIG. 7 is a sectional view of a surface of a secondary crushed particle covered by a second elastomeric layer in accordance with the present invention;

FIG. 8 is a sectional view of a secondary foam material formed into a whole chunk after being pressurized and heated; and

FIG. 9 is a perspective view of a shoe insole of the present invention.

### DETAILED DESCRIPTION OF THE PREFERRED EMBODIMENT

The above and other objects, features and advantages of this disclosure will become apparent from the following detailed description taken with the accompanying drawings.

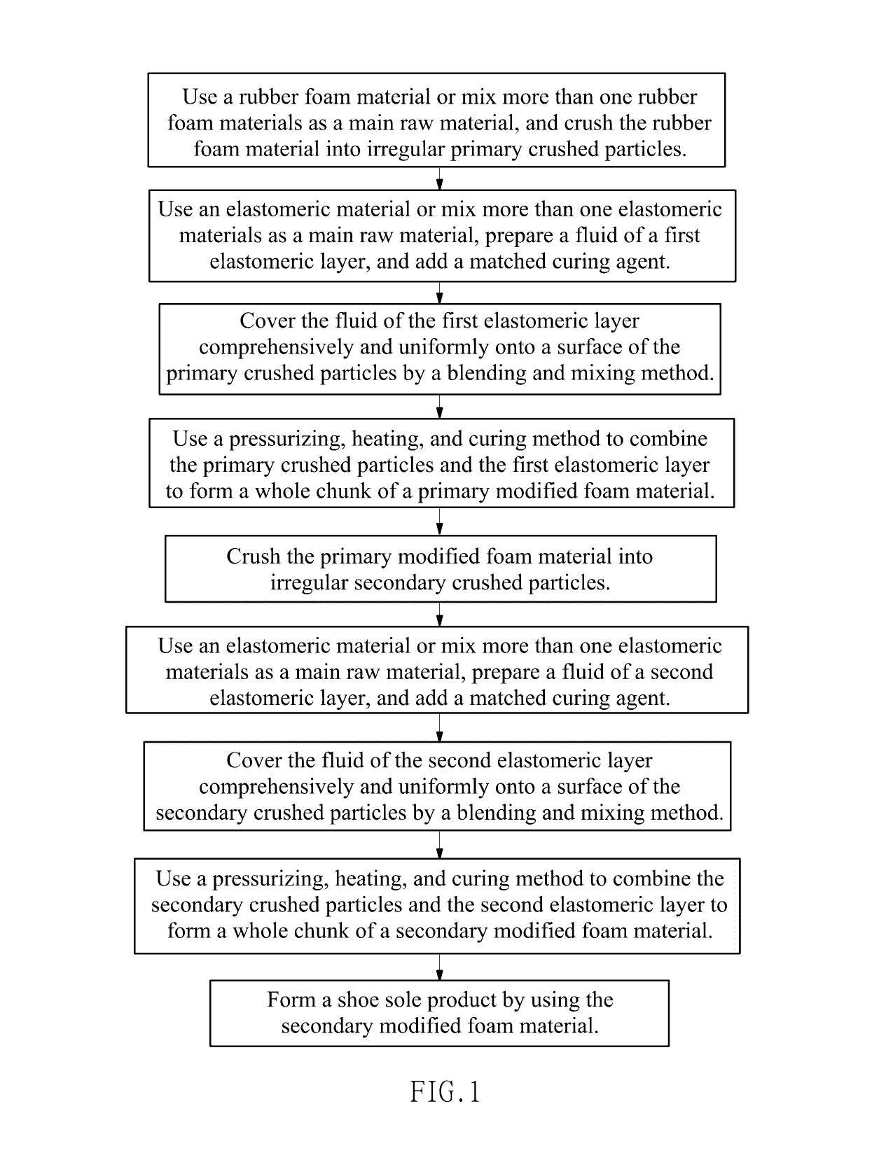

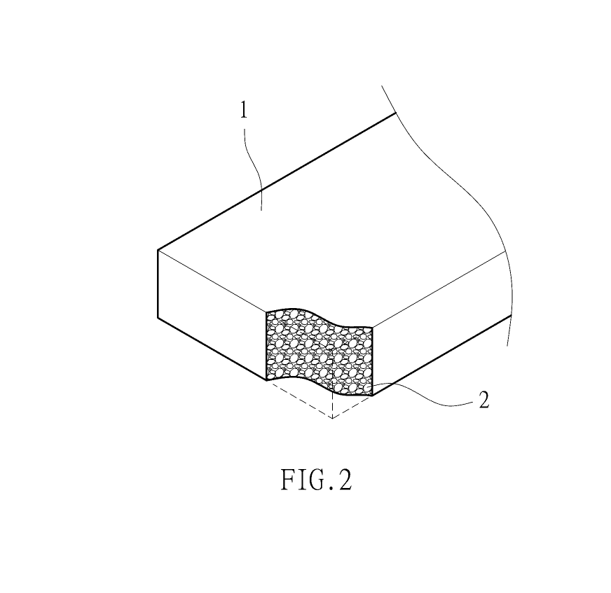

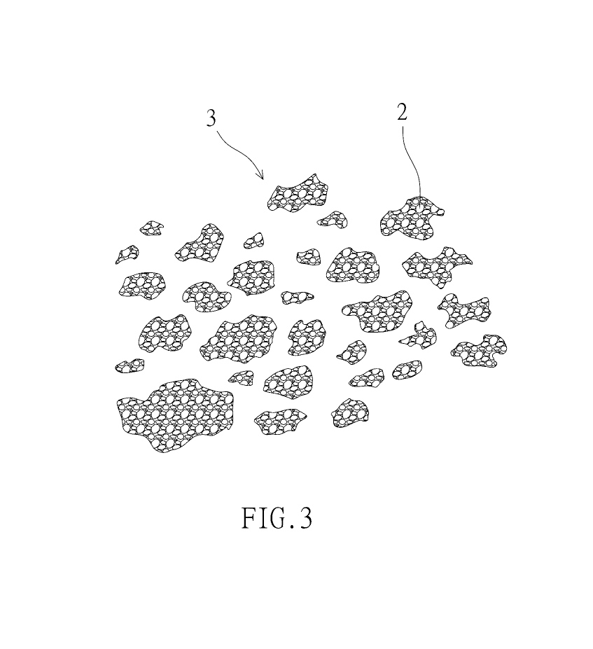

With reference to FIGS. 1 to 9 for the shoe insole manufacturing method of the present invention, one or more rubber foam materials 1 in form of a chunk is used as a raw material (as shown in FIG. 2), and the rubber foam material 1 is consisted of many independent air bubbles 2 formed therein. A crusher is used to crush the foam material 1 into irregular primary crushed particles 3 of 0.1-10 mm (as shown in FIG. 3). In the crushing process, some physical properties of the foam material 1 are damaged naturally, but the primary crushed particles 3 have many concave and convex surfaces and their interior also maintain the structure of the original independent air bubbles 2 and the basic physical properties. Such primary crushed particles 3 are added to the corresponsive surface treatment agent (such as a TPR treatment agent, an EVA treatment agent, a SBR treatment agent, etc) for a surface treatment, and the surface treatment agent acts as a “bridging agent” between the rubber foam material and the elastomer for the effect of anchoring an end to the rubber foam material and the other end into the elastomeric layer to improve the binding effect. However, the surface treatment agent may not be required, depending on the level of compatibility between the compositions of the foam material 1 and the elastomeric material.

A first elastomeric material with selected physical properties is used to prepare the fluid of the first elastomeric layer 4. The type and composition of the first elastomeric material are used to determined the form of fluid, or a solvent is added to prepare the elastomer fluid in form of a solvent, or water is added to prepare a water-soluble elastomer fluid, or a hot-melt elastomer fluid, or a reactive elastomer fluid is formed, or an elastomer fluid of 100% solid is prepared. In the meantime, the fluid of the first elastomeric layer 4 is added to the corresponsive curing agent, and the common ones are a curing agent of isocyanates, or a reactive system having a reactive monomer and an organic metal.

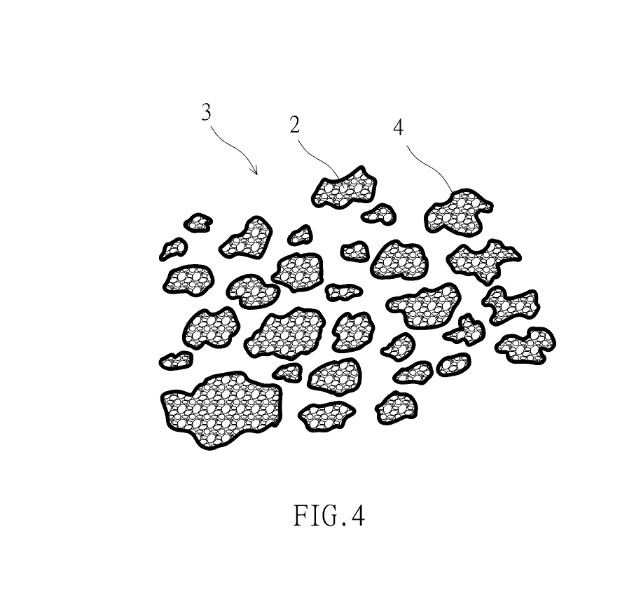

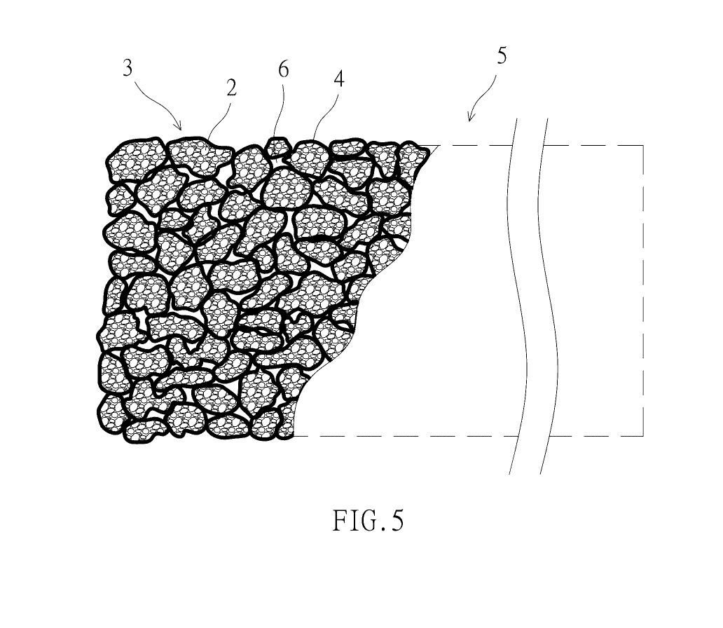

When the primary crushed particle 3 and the fluid of the first elastomeric layer 4 are mixed, they can be mixed by pouring or spraying directly, and the surface of each primary crushed particle 3 must be covered by a layer of the fluid of the first elastomeric layer 4 (as shown in FIG. 4), and then they are put into a mold in a hydraulic machine, and appropriate pressure and heat are applied to cure the fluid of the first elastomeric layer 4, and then the primary crushed particles 3 and the first elastomeric layer 4 are bounded securely with each other to form a whole chunk of the primary modified foam material 5 (as shown in FIG. 5). The primary modified foam material 5 obviously has many first gaps 6 for the comprehensive breathability, but other physical properties still cannot meet the manufacturing requirements and conditions of a food shoe insole, and thus it is necessary to change and enhance the physical properties for the second time.

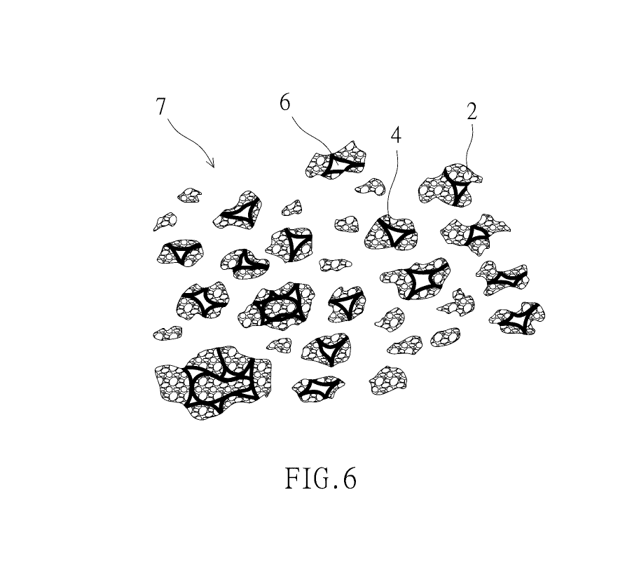

The step of enhancing the physical properties for the second time is described below. Firstly, the whole chunk of the primary modified foam material 5 is crushed into irregular secondary crushed particles 7 of a size of 0.1-10 mm by a crusher (as shown in FIG. 6), and the secondary crushed particle 7 contains many first gaps 6, so that the secondary crushed particle 7 is significantly more breathable than the primary crushed particle 3. Similarly, the crushing process may damage some of the physical properties of the rubber foam material in the primary modified foam material 5 again, but most of the situations will not damage the physical properties of the first elastomeric layer 4, because the first elastomeric layer 4 is much tougher than the rubber foam material 1 and will not be damaged easily in the crushing process. Similarly, the secondary crushed particle 7 has many concave and convex surfaces and the undamaged interior of the primary crushed particle 3 still maintains its structure of original independent air bubbles 2 and basic physical properties and the physical properties of having many first gaps 6 and a comprehensive and uniform first elastomeric layer 4 are added. Similarly, the secondary crushed particles 7 are added into the corresponsive surface treatment agent for the surface treatment to improve the covering and binding effects between the elastomeric material and the surface. However, the surface treatment agent may not be required, depending on the level of compatibility between the compositions of the rubber foam material 1 and the elastomeric material.

A second elastomeric material with selected physical properties is used to prepare a fluid of a second elastomeric layer 8. The fluid form of the elastomeric material is the same as that of the first elastomeric material. The fluid of the second elastomeric layer 8 is added into its corresponsive curing agent, and the common ones include a curing agent of isocyanates or a reaction system having a reactive monomer and an organic metal.

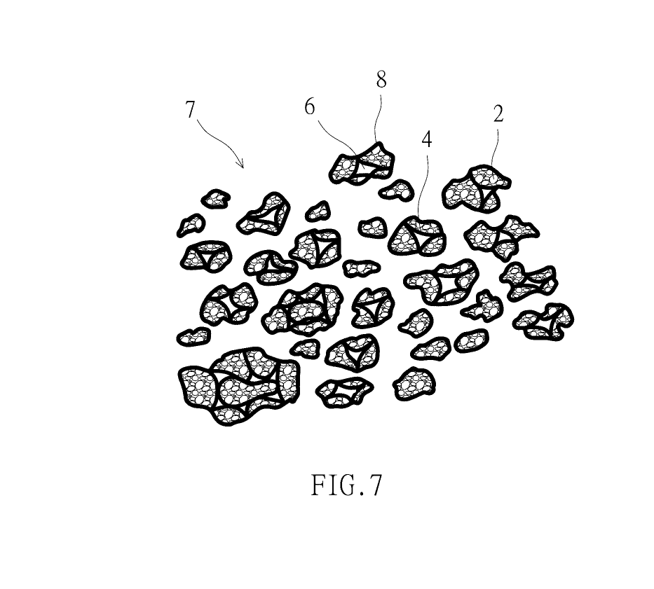

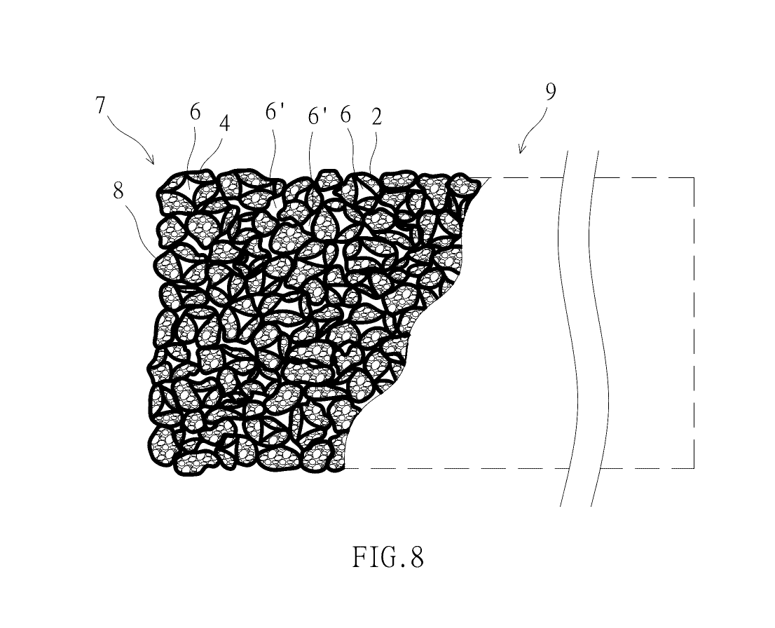

Similarly, the secondary crushed particles 7 and the fluid of the second elastomeric layer 8 may be mixed by pouring or spraying directly, and it is necessary to cover the surface of each secondary crushed particle 7 by a layer of the fluid of the second elastomeric layer 8 (as shown in FIG. 7), and then they are poured into a mold in a hydraulic machine, and appropriate pressure and heat are applied to cure the fluid of the second elastomeric layer 8, and then the secondary crushed particles 7 and the second elastomeric layer 8 are bounded securely with each other to form a whole chunk of the secondary modified foam material 9 (as shown in FIG. 8). The secondary modified foam material 9 obviously has many second gaps 6′ for the comprehensive breathability and also has the physical properties of high density, high elasticity, high compressive strength, low compressibility and very soft comfort, and the advantages of providing high resistance to reduced thickness after a long time of use, low water and sweat absorption, and a quick water and sweat discharging effect.

The rubber foam material 1 of the present invention may be a foam material 1 made of a material such as an ethylene elastomer (including POE, EPDM or any other ethylene), a thermoplastic elastomer (TPE or TPR), Styrene-Butadiene Rubber (SBR), Chloroprene Rubber (CR), Nitrile Butadiene Rubber (NBR) or natural rubber latex or Ethylene Vinyl Acetate (EVA), or a foam material made of a combination of the aforementioned materials in different proportions.

The types of the first elastomeric layer 4 and the second elastomeric layer 8 of the present invention include an elastomeric material such as thermoplastic elastomers (TPR or TPE), Chloroprene Rubber (CR) or thermoplastic polyurethane (PU), or a fluid made of the aforementioned elastomeric materials and an elastomeric material prepared by grafting, modifying, or mixing, and the forms of the fluid may be a solvent containing fluid or not a solvent containing fluid, a water-soluble fluid, or a 100%, two-liquid or hot-melt material, or foam or humidity curing fluid.

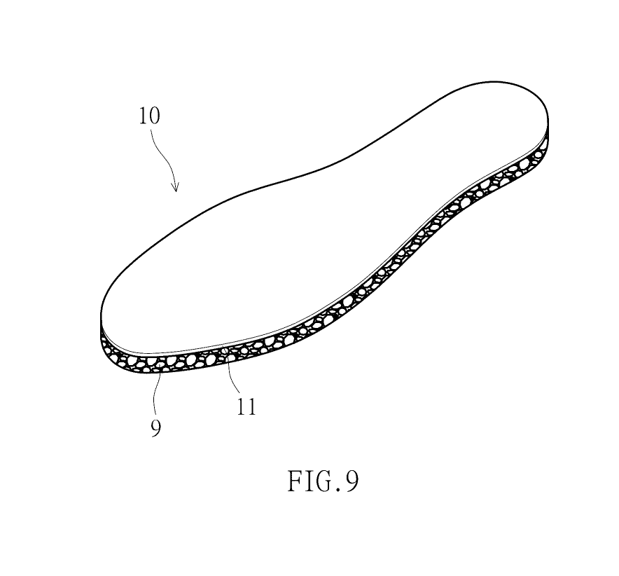

The aforementioned hole chunk of the secondary modified foam material 9 is used for manufacturing the shoe insole 10 according to a conventional shoe insole manufacturing procedure (as shown in FIG. 9). Firstly, the secondary modified foam material 9 is cut into the required thickness, and a top fabric layer 11 or other top material is attached, and then a formation step such as a cold press or a hot press is performed, and finally cut and shaped into a shoe insole 10, or cut directly into a flat shoe insole 10 without shaping.

When a user wears the shoe insole 10 of the present invention for walking or exercising, the sole of the user's foot applies a force F to the top of the shoe insole 10, the applied force F compresses and deforms the secondary crushed particle 7 of the secondary modified foam material 9, and the air between the secondary crushed particles 7 will be compressed to discharge air quickly. As long as the user lifts the foot, the applied force F no longer exists, and the elasticity of the secondary crushed particles 7 and the high elasticity and high compressive strength of the first elastomeric layer 4 and the second elastomeric layer 8 covered onto the surfaces of secondary crushed particles will be rebounded quickly to restore the shoe insole 10 to its original status. When the user wears the shoe insole 10 for walking or exercising, each irregular secondary crushed particle 7 is compressed and rebounded repeatedly to form a compressive and quick air circulation system naturally, and such circulation system allows the user's feet to keep refreshing and comfortable, and the conventional shoe insoles do not have such function which is one of the specific functions of the present invention.

If the rubber foam material 1 comes with a low hardness, a very soft and comfortable shoe insole 10 can be made, and such shoe insole 10 is very helpful to elderly people or patents with foot pains. If the rubber foam material 1 comes with a mid hardness, a load-bearing shoe insole 10 can be made, and such shoe insole 10 is suitable for jogging or mountain climbing. Different shoe insoles 10 can be manufacturing to meet various applications, and that is also one of the specific functions of the present invention. The shoe insole of the present invention not just provides the long-wanted solution to the serious problems of causing the stuffy heat and humidity of feet and producing strange and bad smells only, but also allows manufacturers to manufacture various types of shoe insoles 10 according to the soft, slightly hard, hard, multi-color requirements for different applications. At present, no shoe insole 10 as disclosed in the present invention is available in the market, and thus the present invention is novel.

Preferred embodiments of the present invention are described below:

The first preferred embodiment comprises the steps of using a white TPR foam material 1 as a raw material, wherein the foam material 1 is consisted of 80% SBS and 20% LDPE and whose physical properties include a density of 0.13 g/cm³, a hardness of 25A, a tensile strength of 5.0 Kg/cm², an elongation of 200%, a resilience of 50%, and a compressive strength of 7.5 psi. Firstly, a crusher is used to crush the white TPR foam material 1 into irregular white TPR primary crushed particle 3 with an average particle diameter of 8.5-6.5 mm, and 100 parts are taken. A surface treatment of the primary crushed particle 3 is performed, and the surface treatment comprises the steps of mixing 10 parts of the TPR treatment agent of the shoe material and 45 parts of toluene solvent uniformly, adding and uniformly mixing the primary crushed particles 3, baking the mixture at the temperature of 55-60° C. for approximately 3-5 minutes and letting the mixture cool.

The selected first elastomeric layer 4 is a thermoplastic polyurethane (TPU) elastomer with the physical properties including a density of 1.2 g/cm³, a hardness of 80A, a tensile strength of 250 Kg/cm², an elongation of 500%, a melt index of 30-45, and 30 parts of the thermoplastic polyurethane elastomer are taken and dissolved 30 parts of ethyl acetate solvent to form a viscous fluid of the first elastomeric layer 4 , and then 10 parts of an isocyanates curing agent 10 is added and mixed, and the primary crushed particle 3 processed with the surface treatment is blended uniformly to attach the first elastomeric layer 4 onto the surface of each particle uniformly, and the mixture is poured into a mold of a hydraulic machine, and a pressure of 40 Kg is applied to the mixture, and the mixture is aged at a temperature of 50-55° C. After the mold is opened, a whole chunk of the new-structured white TPR primary modified foam material 5 is formed, and such structure is composed of a surface with many TPR primary crushed particles 3 and attached with a layer of tenacious thermoplastic polyurethane film and has physical properties including a density of 0.25 g/cm³, a hardness of 25-35A, a tensile strength of 6.0 Kg/cm², an elongation of 140%, a resilience of 58%, a compressive strength of 10.5 psi, and a comprehensive breathability, wherein the aforementioned elasticity and compressive strength are still unable to manufacture the desired foam material of the shoe insole, and it is necessary to enhance and reinforce the physical properties of the foam material for the second time.

The step of enhancing and reinforcing the physical properties for the second time includes crushing the white TPR primary modified foam material 5 into irregular white TPR secondary crushed particles 7 with a particle diameter of approximately 5.5-3.5 mm by a crusher, and 100 parts are taken. Similarly, a surface treatment of the secondary crushed particle 7 is performed, and its steps includes mixing 10 parts of the TPR treatment agent 10 of the shoe material and 45 parts of toluene solvent 45 uniformly, adding and mixing the mixture into the secondary crushed particle 7 uniformly, baking the mixture at a temperature if 55-60° C. for approximately 3-5 minutes, performing a surface treatment of the mixture, and cooling the mixture.

The selected second elastomeric layer 8 is also the thermoplastic polyurethane (TPU) elastomer with the aforementioned physical properties, and 30 parts are taken and dissolved into 40 parts of ethyl acetate solvent to form a viscous fluid of a second elastomeric layer 8, and 10 parts of isocyanates curing agent 10 is mixed uniformly and added to the white TPR secondary crushed particle 7 processed with the surface treatment, so that the surface of each particle is attached with a second elastomeric layer 8 of the thermoplastic polyurethane (TPU), and the mixture is poured into a mold of a hydraulic machine, and a pressure of 40 Kg is applied, and the mixture is put aged at a temperature of 50-55° C. After the mold is opened, a whole chunk of a new-structured white TPR secondary modified foam material 9 is formed, and such structure is composed of a surface having many white TPR secondary crushed particles 7 and attached with a layer of tenacious thermoplastic polyurethane film, and new-structured white TPR secondary modified foam material 9 has the physical properties including a density of 0.38 g/cm³, a hardness of 30-40A, a tensile strength of 6.5 Kg/cm², an elongation of 90%, a resilience of 60%, a compressive strength of 15.5 psi, and a better comprehensive breathability. The white TPR secondary modified foam material 9 is cut into the required thickness and size and attached to a top fabric layer 11, and then cut into the desired size, and the shoe insole 10 is formed after a cold press, and a cutting process. Such shoe insole 10 has the features of excellent comprehensive breathability, high elasticity, high compression resistance, mid hardness, high density, etc.

The steps of the second preferred embodiment are described below. A yellow NBR rubber foam material 1 and a black CR rubber foam material 1 are used as raw materials, wherein the yellow NBR foam material 1 has the physical properties including a density of 0.09 g/cm³, a hardness of 14A, a tensile strength of 4.4 Kg/cm², an elongation of 200%, a resilience of 45%, a compressive strength of 3.6 psi, and the black CR rubber foam material 1 has the physical properties including a density of 0.18 g/cm³, a hardness of 4A, a tensile strength of 7.0 Kg/cm², an elongation of 400%, a resilience of 55%, and a compressive strength of 6.4 psi. Firstly, a crusher is used to crush the yellow NBR rubber foam material 1 and the black CR rubber foam material 1 into irregular yellow NBR primary crushed particles 3 with an average particle diameter of approximately 5.5-3.5 mm, and 70 parts of the irregular yellow NBR primary crushed particles 3 and 30 parts of the black CR primary crushed particles 3 are mixed uniformly to form double-density, double-color primary crushed particles 3 without requiring any surface treatment. The selected first elastomeric layer 4 is Chloroprene Rubber (CR) with physical properties including a Mooney viscosity ML(1+4)100° C. of 45-50, a density of 1.2 g/cm³, a hardness of 40A, a tensile strength of 100 Kg/cm², and elongation of 800%. The monomers including CR, Methyl methacrylate, and methacrylate, 2-hydroxyethyl methacrylate are grafted and reacted, and then prepared and formed into a CR elastomer solution containing 50% of methyl cyclohexane and methyl ethyl ketone, and 80 parts are taken, and the mixture is added and mixed into the isocyanates curing agent, and 8 parts are taken and added and mixed into the aforementioned double-density, double-color primary crushed particle 3, so that the surface of each particle is attached uniformly with a first elastomeric layer 4 made of Chloroprene Rubber (CR), and the mixture is poured into a mold of a hydraulic machine, and a pressure of 20 Kg is applied, and the mixture is aged at a temperature of 50-55° C. After the mold is opened, a whole chunk of the double-density, double-color primary modified foam material 5 is formed, and such structure is composed of a surface with many double-density, double-color primary crushed particles 3 and attached with a layer of tenacious modified CR film. The double-density, double-color primary modified foam material 5 has the physical properties including a density of 0.24 g/cm³, a hardness of 6-16A, a tensile strength of 5.2 Kg/cm², an elongation of 150%, a resilience of 55%, a compressive strength of 8.5 psi, and a comprehensive breathability. The aforementioned elasticity and compressive strength are still unable to manufacture the desired foam material of the shoe insole 10, and it is necessary to enhance and reinforce the physical properties for the second time.

The step of enhancing and reinforcing the physical properties for the second time is described below. The double-density, double-color primary modified foam material 5 is crushed into irregular double-density, double-color secondary crushed particles 7 with a particle diameter of approximately 5.5-3.5 mm by a crusher, and 100 parts are taken and used, wherein the second elastomeric layer 8 can be combined very well without requiring any resurface treatment.

The selected second elastomeric layer 8 may be a thermoplastic polyurethane (TPU) elastomer with the same specification as the first preferred embodiment, and 30 parts are taken and dissolved into 40 parts of ethylene acetate solvent to form a viscous fluid of the second elastomeric layer 8, and then added and mixed into 10 parts of the isocyanates curing agent 10, and finally added and mixed into the aforementioned double-density, double-color secondary crushed particles 7, so that the surface of each particle is uniformly attached with a second elastomeric layer 8 of the thermoplastic polyurethane (TPU) elastomer, and the mixture is poured into a mold of a hydraulic machine, and a pressure of 20 Kg is applied, and the mixture is aged at a temperature of 50-55° C. After the mold is opened, a whole chunk of the double-density, double-color secondary modified foam material 9 is formed, and such structure is formed by a surface having many double-density, double-color secondary crushed particles 7 and attached with a layer of tenacious thermoplastic polyurethane film. The structure has the physical properties including a density of 0.35 g/cm³, a hardness of 6-18A, a tensile strength of 7.0 Kg/cm², an elongation of 110%, a resilience of 65%, a compressive strength of 13.0 psi, and a better comprehensive breathability. The double-density, double-color secondary modified foam material 9 is cut into the required thickness and size and attached to a top fabric layer, and then further cut to form the shoe insole 10, and such shoe insole 10 has the advantages of excellent comprehensive breathability, high elasticity, high compression resistance, low hardness, and very soft comfort.

What is claimed is:

1. A shoe insole manufacturing method, comprising the steps of:
(a) using a rubber foam material or mixing more than one rubber foam materials as a main raw material, and crushing the rubber foam material into irregular primary crushed particles;
(b) using an elastomeric material or mixing more than one elastomeric materials as a main raw material, preparing a fluid of a first elastomeric layer, and adding a matched curing agent;
(c) covering the fluid of the first elastomeric layer comprehensively and uniformly to onto a surface of the primary crushed particles by a blending and mixing method;
(d) using a pressurizing, heating, and curing method to combine the primary crushed particles and the first elastomeric layer to form a whole chunk of a primary modified foam material;
(e) crushing the primary modified foam material into irregular secondary crushed particles;
(f) using an elastomeric material or mixing more than one elastomeric materials as a main raw material, preparing a fluid of a second elastomeric layer, and adding a matched curing agent;
(g) covering the fluid of the second elastomeric layer comprehensively and uniformly onto a surface of the secondary crushed particles by a blending and mixing method;
(h) using a pressurizing, heating, and curing method to combine the secondary crushed particles and the second elastomeric layer to form a whole chunk of a secondary modified foam material; and
(i) forming a shoe sole product by using the secondary modified foam material.

2. The shoe insole manufacturing method of claim 1, wherein the surface treatment agent added into the primary crushed particles of Step (a) or the secondary crushed particle of Step (e) is processed with a surface treatment in advance.

3. The shoe insole manufacturing method of claim 1, wherein the secondary modified foam material is composed of a foam material of 85 to 35% by weight, an elastomeric material of 15 to 60% by weight and a curing agent of 0 to 5% by weight.

4. The shoe insole manufacturing method of claim 1, wherein the primary crushed particles or the secondary crushed particles are crushed into a range of 0.1-10 mm.

5. The shoe insole manufacturing method of claim 1, wherein the foam material in Step (a) is an ethylene elastomer (POE or EPDM or any other ethylene), Styrene-Butadiene Rubber (SBR), Chloroprene Rubber (CR), Nitrile Butadiene Rubber (NBR), Thermo Plastic Elastomer (TPE or TPR), natural rubber latex, Ethylene Vinyl Acetate (EVA) or a foam material manufactured by mixing the raw materials above in different proportions.

6. The shoe insole manufacturing method of claim 1, wherein the elastomeric material in Step (b) or Step (f) is a Thermo Plastic elastomer (TPR or TPE), Chloroprene Rubber (CR), thermoplastic polyurethane (PU) or an elastomeric material manufactured by the materials above.

7. The shoe insole manufacturing method of claim 1, wherein the curing agent in Step (b) or Step (f) is an isocyanate or a reaction system composed of a reactive monomer and an organic metal.

8. The shoe insole manufacturing method of claim 1, wherein a first gap is formed between the primary crushed particles during the combining process of forming the primary modified foam material in Step (d); and a second gap is formed between the secondary crushed particles during the combining process of forming the secondary modified foam material in Step (h).

9. The shoe insole manufacturing method of claim 1, wherein the foam material is a monochromatic or multi-color foam material and the secondary modified foam material is a monochromatic or multi-color composite.

10. The shoe insole manufacturing method of claim 1, wherein the foam material is composed of foam material of a mono density or foam materials of two or more densities, so that the primary modified foam material and the secondary modified foam material are mono-density or multi-density composite.

11. A shoe insole, manufactured by the method according to claim 1.

12. The shoe insole of claim 11, wherein the shoe insole has a top fabric layer disposed thereon.

13. A shoe insole, manufactured by the method according to claim 3.

14. The shoe insole of claim 13, wherein the shoe insole has a top fabric layer disposed thereon.
